(19) United States
(12) Patent Application Publication
(10) Pub. No.: US 2007/0200390 A1
(43) Pub. Date: Aug. 30, 2007

(54) AERODYNAMIC STRUCTURES FOR TRACTOR TO TRAILER JUNCTION

(76) Inventors: Alexey Anatolievich Lotarev, Saint-Petersburg (RU); Dmitry Nikolayevich Logatchev, Saint-Petersburg (RU); Maxim Nikolayevich Yazev, Saint-Petersburg (RU); Vladimir Petrovich Vasil'yev, Saint-Petersburg (RU); Alexander Vitaliyevich Medvedev, Saint-Petersburg (RU); Vasiliy Gennadievich Abashkin, Saint-Petersburg (RU); Leonid Malinin, Newton, MA (US)

Correspondence Address: Harry A. Hild, Jr.;Alcoa Technical Center, Intellectual Property, Building C, 100 Technical Drive, Alcoa Center, PA, 15069-0001, US

(21) Appl. No.: 11/669,877

(22) Filed: Jan. 31, 2007

Related U.S. Application Data
(60) Provisional application No. 60/764,082, filed on Jan. 31, 2006.
(60) Provisional application No. 60/764,078, filed on Jan. 31, 2006.

(51) Int. Cl. B62D 35/00

(52) U.S. Cl. 296/180.2

(57) ABSTRACT

The present invention provides an air shield comprising side panel assemblies in hinged connection to each rear edge of a sidewall of a tractor and an actuation assembly including a boss in rotational engagement to the frame of the tractor and between a cab and a fifth wheel of the tractor, a lever having an adjustable length engaged to the boss at a first end and engaged to side panel assembly at a second end, and a spring including a first end connected to the side panel assembly and a second end connected to the frame of the tractor between the boss and the rear of the trailer frame.

### CROSS REFERENCE TO RELATED APPLICATION

The present invention claims the benefit of U.S. provisional patent application 60/764,082 filed on Jan. 31, 2006, the whole contents and disclosure of which is incorporated by reference and also claims the benefit of U.S. provisional patent application 60/764,078 filed on Jan. 31, 2006, the whole contents and disclosure of which is incorporated by reference as is fully set forth herein.

### FIELD OF THE INVENTION

The present invention is related to structures and arrangements that in one embodiment reduces aerodynamic drag in moving vehicles.

### BACKGROUND OF THE INVENTION

The semi-trailer truck (tractor) and junction to a trailer, as used for hauling cargo, has advantages over the conventional straight trucks in that it can carry a greater cargo and is more adaptable for steering in close quarters. One disadvantage, however, is that there is a gap between the tractor and trailer that creates aerodynamic drag. The gap between the tractor and trailer tends to trap air creating a low-pressure wake behind the tractor, resulting in a net pressure difference and, therefore, creating drag. The gap distance between the tractor-trailer combination is dependent on the position of the fifth wheel. The fifth wheel is a bearing, which serves as a coupling between the tractor and trailer. Additionally, increases to airflow pressure of the front surfaces of the vehicle, such as the portion of the trailer having a greater height then the top surface of the tractor roof, also produce resistance to the forward motion of the vehicle.

### SUMMARY OF THE INVENTION

Generally speaking, the present invention in one embodiment provides panels that substantially cover the gap between the rear face of the tractor and the front face of the trailer, wherein the panels are adjustable to compensate for directional changes of the tractor in relationship to the trailer. In one embodiment, an air shield is provided extending between the sidewalls of a tractor and a trailer, in which the air shield includes:

side panel assemblies in hinged connection to a rear edge of each sidewall of a tractor, each of the side panel assemblies including a first panel in hinged engagement to a second panel, wherein the first panel is the hinged connection portion of the side panel assembly to the tractor, and the second panel is orientated to contact a trailer with at least one roller; and

an actuation assembly including a boss in rotational engagement to the frame of the tractor and positioned between a cab and a fifth wheel of the tractor, a lever having an adjustable length engaged to the boss at a first end and engaged to second panel at a second end, and a spring including a first end connected to the second panel and a second end connected to the frame of the tractor between the boss and the rear of the trailer frame.

In one embodiment, the air shield arrangement may provide a tractor cab extension. In one embodiment, the tractor cab extension includes two side panel assemblies, which may also be referred to as deflectors, installed to each sidewall of the tractor cab. Each of the sidewall assemblies include hinge connected front and rear panels, wherein the front panel may be hinge connected to the tractor cab at of the edge defined by the intersection of the sidewall to the rear face of the tractor cab. In one embodiment, the device also includes a lever that is rotationally mounted at its first end onto the longitudinal beam of the tractor chassis near the rear face of the tractor cab, wherein the second end of the lever is connected to the lower edge of the second panel. In one embodiment, the lever and lower edge of the second panel is lower than the lower surface of the trailer. In one embodiment, the device is also equipped with a spring, one end of which is secured to the first end of the lever and the other end of being secured on the longitudinal beam of the chassis near the fifth wheel of the tractor.

In another aspect of the invention, an air shield is provided by an adjustable roof fairing extending from the top surface of the tractor roof to the top surface of the trailer. In one embodiment, the air shield includes:

a panel in hinged engagement to a roof of a tractor, the panel having a length at least greater than a dimension separating a rear face of the tractor from a front face of a trailer;

a panel spring having a first end connected to the panel and a second end connected to the roof of the tractor; and

an actuating system including at first and at least a second vertical rod, wherein each of the first and the at least the second vertical rod is in sliding engagement to the rear face of the tractor by at least an upper and lower guide, and is connected to the rear face of the tractor by at least one rod spring; an upper beam connected at a first end to the upper guide for each of the first and the at least second vertical rod; and a lower beam connected to a portion of each of the first and the at least second vertical rod, wherein each of the upper beam and the lower beam intersect at a second end.

### BRIEF DESCRIPTION OF THE DRAWINGS

The following detailed description, given by way of example and not intended to limit the invention solely thereto, will best be appreciated in conjunction with the accompanying drawings, wherein like reference numerals denote like elements and parts, in which:

FIG. 1 depicts a side view of a tractor and trailer combination equipped with one embodiment of an air shield arrangement having cab extenders, in accordance with the present invention.

FIG. 2 depicts a top view of a tractor without a trailer equipped with one embodiment of an air shield arrangement, in accordance with the present invention.

FIGS. 3-5 depict top views illustrating the operation of one embodiment of an air shield arrangement, in accordance with the present invention.

FIG. 6 shows a cross sectional side view of one embodiment of a lever and boss assembly, in accordance with the present invention.

FIG. 7 depicts a top view of the lever and boss assembly depicted in FIG. 6.

FIG. 8 shows a cross sectional side view of one embodiment of a lever and boss assembly, in accordance with the present invention.

FIG. 9 depicts a top view of the lever and boss assembly depicted in FIG. 8.

FIG. 10 depicts a side view of a tractor and trailer equipped with one embodiment of an air shield arrangement having an adjustable roof fairing corresponding to the junction of the tractor and the trailer, in accordance with the present invention.

FIG. 11 depicts a top view of the tractor and trailer combination equipped with one embodiment of an air shield arrangement having an adjustable roof fairing, as depicted in FIG. 10.

FIG. 12 depicts a side view of one embodiment of an adjustable fairing actuation system, in accordance with the present invention.

FIG. 13 depicts a rear view of the embodiment of an adjustable fairing actuation system, as depicted in FIG. 12.

FIG. 14 depicts a side view of a tractor and trailer combination equipped with one embodiment of an air shield arrangement having an adjustable roof fairing corresponding to the junction of the tractor and the trailer, in accordance with the present invention.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

For the purposes of the description hereinafter, the terms “upper”, “lower”, “front”, “rear”, “top” and “bottom”, and derivatives thereof shall relate to the invention, as orientated in the embodiments depicted in the figures.

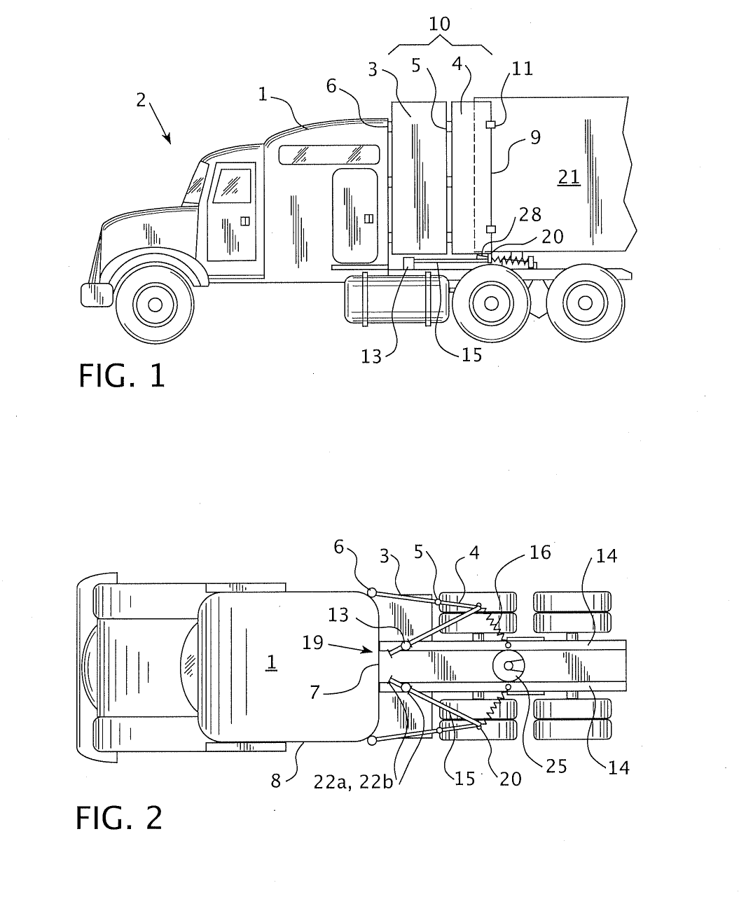

Referring to FIGS. 1-3, in one embodiment, an air shield arrangement is provided in the form of cab extenders including sidewall panel assemblies 10 extending from the rear sidewall surfaces of the cab 1 of tractor 2 to the trailer 21, in which the gap between the tractor cab I and the trailer 21 may be covered by the sidewall panel assemblies 10. An air shield is a structure that deflects airflow and in one embodiment of the present invention deflects airflow beyond the gap positioned between the cab 1 and the trailer 21. In one embodiment, each sidewall panel assembly 10 includes two panels 5, 6 positioned corresponding to each of the sidewalls of the cab 1, wherein in one embodiment the first panel 3 (also referred to as front panel) and the second panel 4 (also referred to as rear panel) are connected by hinged engagement through at least one hinge 5, which in one embodiment is positioned at the adjacent edges of the first and second panel 3, 4. In one embodiment, the first panel 3 is in a hinged connection by at least one hinge 6 to the cab 1 of the tractor 2, wherein the hinge(s) 6 may be positioned between at an edge of the cab 1 defined by the intersection of the rear wall 7 and the sidewall 8 of the cab 1 of tractor 2. The second panel 4 is orientated to contact the sidewall 12 of the trailer 21 when being connected to the tractor 2. In one embodiment, the edge 9 of second panel 4 opposite the hinged edge (hereinafter referred to as the free edge 9) is equipped with rollers 11, which in one embodiment include an axis of rotation that is substantially parallel to the free edge 9. In one embodiment, at least one of the first and the second panels 3, 4 is composed of a metal, such as an aluminum alloy. In another embodiment, at least one of the first and second panels 4, 5 is composed of a plastic or composite material.

In one embodiment, the air shield includes a lever and spring assembly for actuating (also referred to as the actuating assembly) the sidewall panel assemblies 10. In one embodiment, the actuation assembly including a boss 13 mounted to a first portion of the frame of the tractor 2, an adjustable lever 15 connecting the boss 13 to a portion of the sidewall panel assemblies 10, and a spring 16 mounted to a second portion of the frame and connected to the adjustable lever 15.

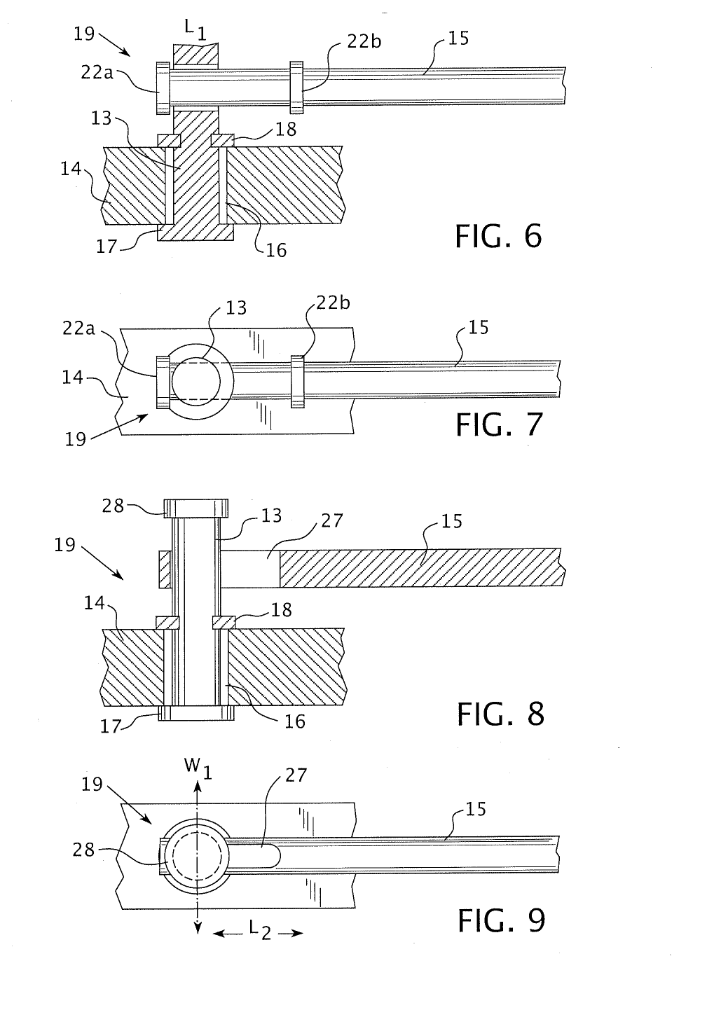

Referring to FIGS. 6-9, in one embodiment, the boss 13 extends vertically from the frame of the tractor 2. In one embodiment, the boss 13 is positioned between the cab 1 and a fifth wheel 25 of the tractor 2. In another embodiment, the boss may be rotationally mounted to the frame of the tractor 2. In an even further embodiment, the rotational relationship is provided by mounting the boss 13 through a substantially circular eyelet 16 formed through the frame, wherein the portion of the boss 13 corresponding to the underside of the frame has a head 17 having a greater width then the portion of the boss 13 extending through the eyelet 16 in the frame. In one embodiment, a bushing assembly 18 is fixed on the opposite side of the fame at which the head 17 of the boss 13 is positioned allowing rotational movement of the boss 13 about the longitudinal centerline L1 of the boss 13.

Referring to FIGS. 6-9, in one embodiment the lever 15 having the adjustable length is engaged to the boss 13 at a first end 19, and is engaged to the second panel 4 at a second end 20. In another embodiment, the second end 20 of the lever 15 is connected to the edge of the second panel 4 defined at the intersection of the free edge 9 and the base edge 28 of the second panel 4.

Referring to FIGS. 6 and 7, in one embodiment, the adjustable length of the lever 15 is provided by a lever 15 being slideably engaged to an eyelet formed in the boss 13, wherein the lever 15 further comprises retainers 22a, 22b on opposing sides of the boss 13. The retainers 22a, 22b are positioned to allow the lever 15 to slide a predetermined distance during the operability of the cab extenders. In one embodiment, the retainer 22b corresponding to the end 20 of the lever 15 that is in closer proximity to the trailer 21 is positioned to allow the panel assemblies 10 to deflect at the hinge 5, and to allow the lever 15 to rotate about the longitudinal axis L1 of the boss 13, as the free edge 9 of the second panel 4 is displaced to the edge of the trailer 21 corresponding to the intersection of the forward face 26 and the sidewall 21 of the trailer 21, as depicted in FIG. 4.

Referring to FIG. 5, in one embodiment, as the free edge 9 of the second panel 4 is displaced past the edge of the trailer 21 and traversed along the sidewall 12 of the trailer 21, the lever 15 is slideably displaced from a first position dictated by the retainer 22b, which is in closest proximity to the trailer 21, to a second position at which the lever 15 is obstructed from further displacement by the retainer 22a positioned closer to the cab 1 of the tractor 2, wherein in the second position the adjustable lever 15 may be fully extended. In one embodiment, the exact placement of the retainers 22a, 22b are at least partially dependent on the dimensions of the panel assemblies 10, the width of the cab 1 defined by the cab's opposing sidewalls 12 the width of the trailer 21 defined by the trailer's opposing sidewalls, and the desired length at which at least the second panel 4 of the panel assembly 10 will overlap the sidewall 12 of the trailer 21.

Referring to FIGS. 8-9, in another embodiment, the lever 15 having an adjustable length is provided by an eyelet 27 formed in the lever 15, wherein the eyelet 27 of the lever 15 is slideably positioned over the boss 13 positioned within the eyelet 27. In one embodiment, the lever 15 is positioned between a head 28 of the boss 13 having dimensions being at least greater than the transverse width W1 of the eyelet 27 in the lever 15, and the portion of the frame to which the boss 13 is mounted. The longitudinal length L2 of the eyelet 27 is selected to provide the function described above with respect to the retainers 22a, 22b, as depicted in FIGS. 6 and 7. More specifically, in one embodiment the longitudinal length L2 of eyelet 27 is equal to specified longitudinal travel of lever 15.

Referring to FIGS. 1-5, in one embodiment the spring 16 of the actuating assembly includes a first spring end connected to the second end of the lever 15 corresponding to the free edge 9 of the second panel 4, and a second spring end connected to the frame of the tractor 2 between the boss 13 and the rear of the trailer frame. In one embodiment, the second end of the spring 16 is connected to a portion of the frame corresponding to the fifth wheel 25.

In one embodiment, the side panel assemblies 10 and actuation system operate as depicted in FIGS. 2-5. Referring to FIG. 2, prior to the junction of the trailer 21 to the tractor 2, the first and second panels 3 and 4 of the side panel assembly 10 are positioned as dictated by the force applied by springs 16 to the second end 20 of the lever 15, wherein the force applied by the springs 16 to the lever is in a direction towards the point at which the spring is mounted to the tractor frame. In this configuration, the adjustable lever 15 is being displaced by the spring 16 to provide a dimension between the boss 13 and the free edge 9 of the panel assembly 10 that is at its shortest length as determined by retainers 22a, 22b, as depicted in FIGS. 6 and 7, or the longitudinal length of the eyelet 17, as depicted in FIGS. 8 and 9.

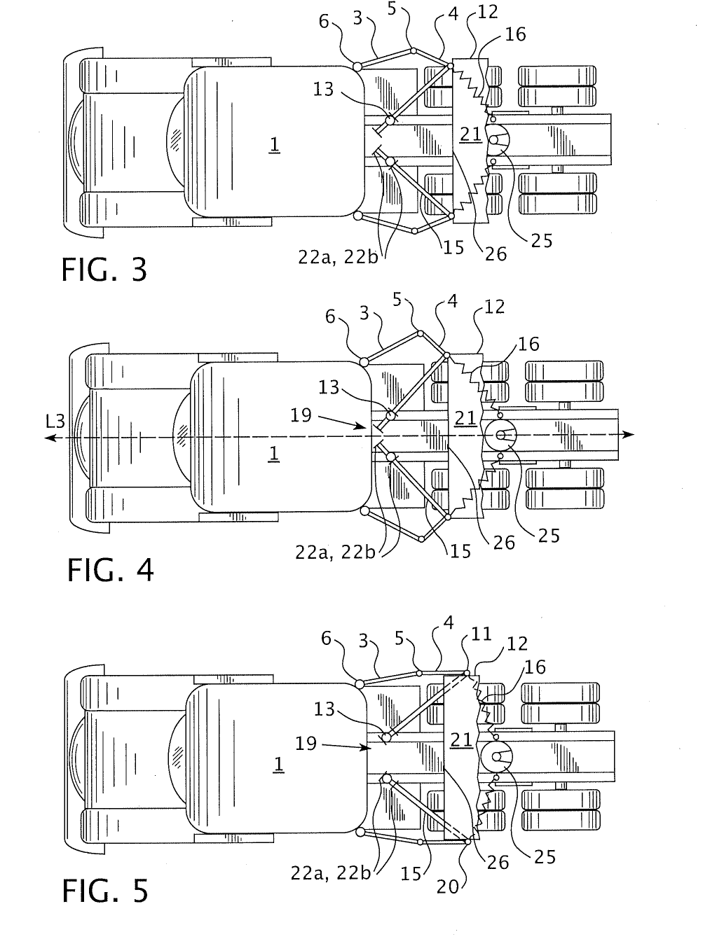

Referring to FIG. 3, in the process of trailer 21 coupling to the fifth wheel 25, as the trailer 21 approaches the rear face 7 of the cab 1 the front face 26 of trailer 21 meets the rollers 9 that are positioned on the free edge 9 of the second panel 4. In response to the force applied by the front wall 26 of the trailer 21, and the first and second panels 3, 4 begin folding at the hinge 5 between the first and second panels 3,4, and the first panel 3 rotates outward relative to the longitudinal centerline L3 of the tractor 2 as the lever 14 starts rotating about the boss's axis. In this process, the lever 14 translates the free edge 9 of the second panel 4 via the rollers 11 along the front face 26 of trailer 21 until reaching the edge of the trailer 21 corresponding to the intersection of the forward face 26 and the sidewall 12 of the trailer 21, as depicted in FIG. 4.

Referring to FIG. 5, as front face 26 of the trailer 21 continues to move into closer proximity cab 1, the free edge 9 of the second panel 4 is displaced past the edge of the trailer 21 and is traversed along the sidewall 12 of the trailer 21, wherein the lever 15 rotates in a direction toward the lever's original position prior to the contact of the free end 9 of the panel assembly 10 to the front face 26 trailer, as depicted in FIG. 2. In one embodiment, in response to the force applied to the adjustable lever 15 by the spring 16 as the free edge 9 is traversed along the sidewall 12 of the trailer 21 the adjustable lever 15 is displaced from a first positioned defined as the shortest distance between the boss 13 and the second end 20 of the lever 15 to an extended second position in which the distance between the boss 13 and the second end 20 of the lever 15 is defined by the retainer 22b that is in closest proximity to the cab 1.

In one embodiment, the gap between cabin 1 of tractor 2 and the trailer 21 will be covered by the first and second panels 3, 4; and the second panel 4 will be pressed against the sidewall 12 of trailer 21 by the force provided by the springs 16. Further, during turning motions as the trailer 21 revolves with respect to the axis of fifth wheel 20, the rollers 11 roll along the sidewall 12 of trailer 21 wherein the force provided by the spring 16 maintains that at least the second panel 4 of the panel assembly 10 is pressed against the sidewall of trailer 21.

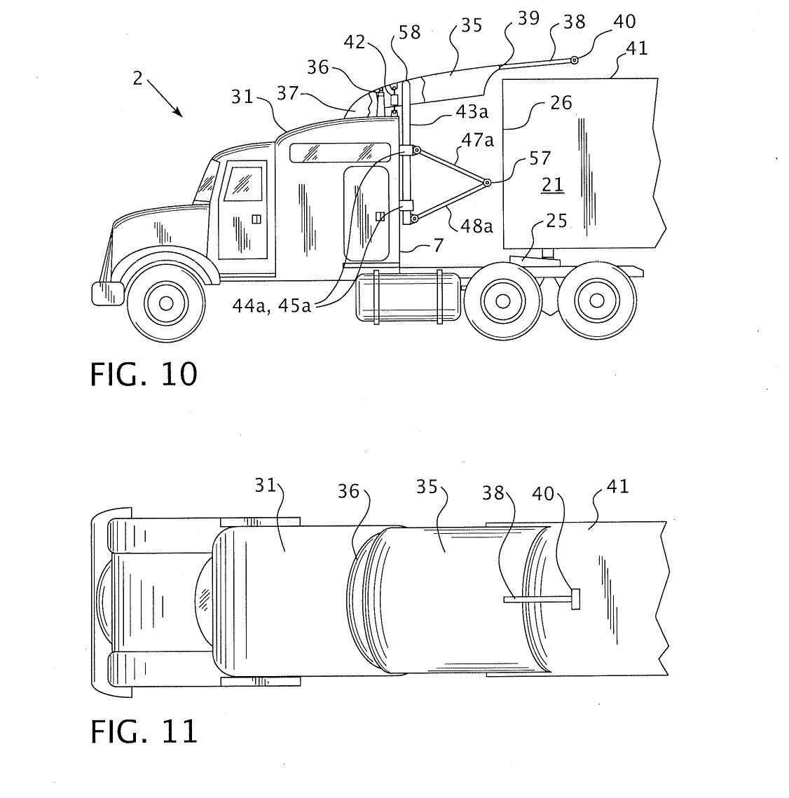

Referring to FIGS. 10 and 11, in another aspect of the present invention an air shield arrangement is provided by an adjustable roof fairing system 30 configured for use in tractor trailer combinations. In one embodiment, the adjustable roof fairing system 30 adjusts the angle of inclination of the roof fairing 35 depending upon the relationship between the height of the roof 31 of the cab 1 of the tractor 2, and the height of the front face 26 of the trailer 21 being towed. In one embodiment, the adjustable roof fairing system includes a fairing panel 35 in hinged engagement to the roof surface 31 of a tractor 2, a panel spring 42 mounted between the fairing panel 35 and the upper surface 31 of the roof, and a mechanical actuation system.

In one embodiment; the fairing panel 35 is in hinged engagement through a hinge 36 to the upper surface 31 of the roof of the tractor 2, wherein the roof of the tractor 2 may be provided by the cab 1. In one embodiment, the adjustable fairing panel 35 may include a convex upper surface. In another embodiment, the adjustable fairing panel 35 may be composed of a metal, such as aluminum, or may be composed of a plastic or composite material. The term “adjustable fairing panel” denotes that the fairing is in hinged connection and may be rotated to compensate for the differences in height between the upper surface 3 1 of the tractor 2 and the upper surface of the trailer 21 in covering the gap positioned therebetween. In one embodiment, a fixed fairing 37 is positioned in front of the adjustable fairing panel 35.

In one embodiment, the fairing panel 35 further comprises a longitudinal beam 38 extending from at least the trailing edge 39 of the fairing panel 35, and configured for contacting the upper surface 41 of the trailer 21, when the trailer 21 is joined to the tractor 2 by engagement through a fifth wheel 25. In one embodiment, the longitudinal beam 38 further comprises a roller 40 positioned at the end of the longitudinal beam 38 opposite the end that is in closest proximity to the trailing edge 39 of the fairing panel 35. In one embodiment, the fairing panel 35 has a length at least greater than a dimension separating a rear face 7 of the tractor cab 1 from a front face 26 of a trailer 21. In one embodiment, at least one panel spring 42 is provided having a first end connected to the fairing panel 35 and a second end connected to a portion of the roof 31 of the tractor 2, such as the roof of the cab 1. In one embodiment, the panel spring 42 communicates a downward force to the fairing panel 35.

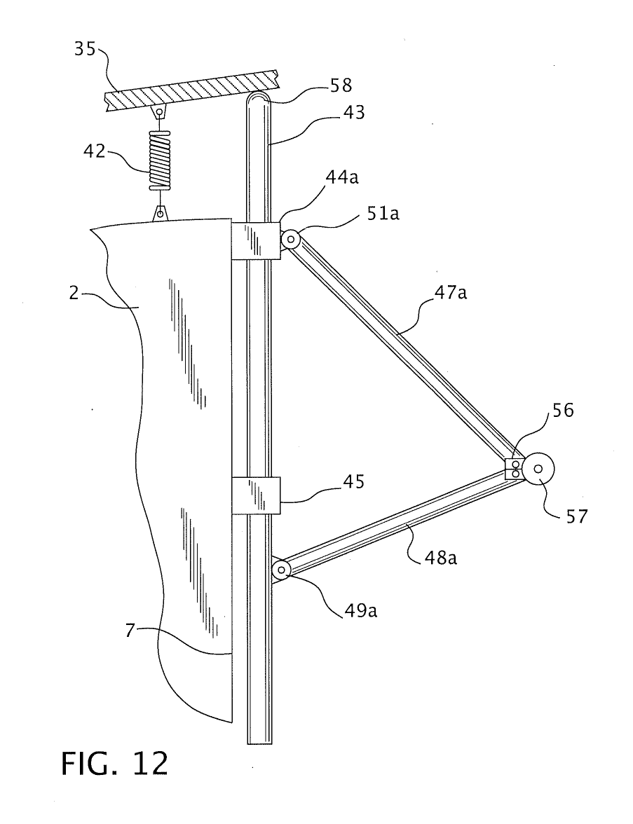

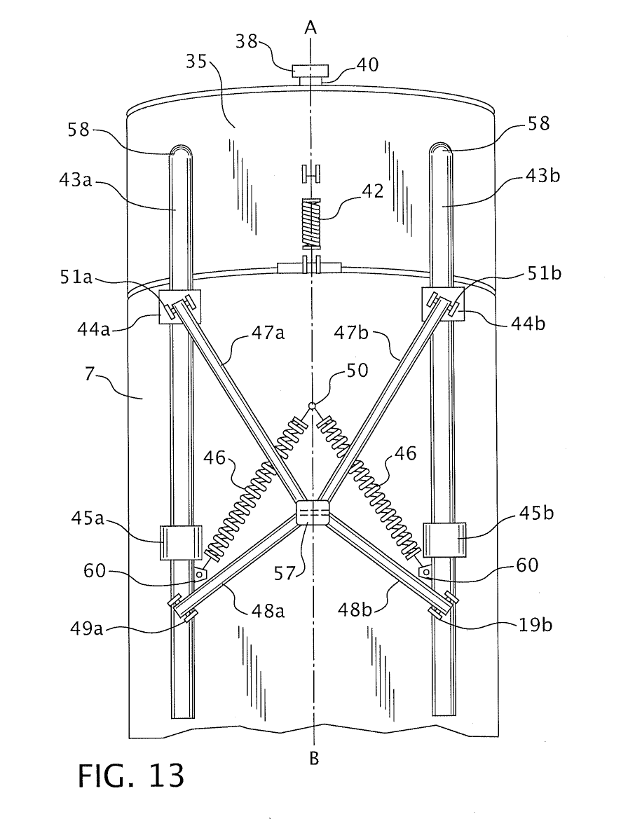

Referring to FIGS. 12 and 13, in one embodiment, the mechanical actuating system for the fairing panel 35 includes a first and at least a second vertical rod 43a, 43b, upper and lower levers 44a, 44b, and at least one rod spring 46. In one embodiment, a first vertical rod 43a is positioned on one side of the rear face 7 of the tractor 2 and second vertical rod 43b is position on a second side of the rear face 7 of the tractor 2, wherein the opposing sides are separated by a vertical centerline A B. The first and the at least the second vertical rod 43a, 43b are in sliding engagement to the rear face 7 of the tractor 2 by at least an upper guide 44a, 44b and at least one lower guide 45a, 45b. In one embodiment, the upper portion 58 of the vertical rods 43a, 43b is orientated to contact the lower surface of the fairing panel 35. In another embodiment, the vertical rod 43a, 43b has a cylindrical cross section.

At least one rod spring 46 is mounted from the rear face 7of the tractor 2 to the vertical rods 43a, 43b. In one embodiment, the at least one rod spring 46 is a compression spring communicating an upward force to the fairing panel 35. In one embodiment, a first end of the rod spring 46 is mounted at a point 50 on the vertical centerline AB of the rear face 7 of the tractor 2 and the second end of the rod spring 46 is mounted to a portion of the vertical rod 43a, 43b below the lower guide 45a, 45b. In one embodiment, the point 50 at which the rod spring is mounted to the rear face 7 of the tractor 2 is higher than the point 60 at which the rod spring 46 is connected to vertical rods 43a, 43b.

Referring to FIGS. 12 and 13, in one embodiment, the upper beam 47a, 47b is connected at a first end to the upper guide 44a, 44b for each of the vertical rods 43a, 43b; and a lower beam 48a, 48b is connected at a first end to a portion of each of the vertical rods 43a, 43b, wherein each of the upper beams and the lower beams 47a, 47b, 48a, 48b intersect at a second end. The intersect at the second end of the upper beams and the lower beams 47a, 47b, 48a, 48b form a four-faceted pyramid. In one embodiment, the intersect point between each of the upper beams and the lower beams 47a, 47b, 48a, 48b is provided by a hinged engagement 56. In one embodiment, the intersect at the second end between each of the upper beams and the lower beams 47a, 47b, 48a, 48b further comprises a roller 57. In one embodiment, the lower beam is 48a, 48b connected to each of the vertical rods 43a, 43b at a hinged engagement 49a, 49b. In one embodiment, the upper beam 47a, 47b is connected to each of the upper guides 44a, 44b, by a hinged engagement 51a, 51b.

Referring to FIG. 10, before the trailer 21 is connected to the tractor 2 the fairing panel 35 is orientated in an extended position, since upper ends 58 of vertical rods 43a, 43b are pressed upwards against the lower surface of the fairing panel 35, and the upward force generated by the rod springs 46 communicated to the vertical rods 43a, 43b exceeds the downward force generated by the weight of the roof fairing assembly in combination with the downward force produced by the panel spring 42.

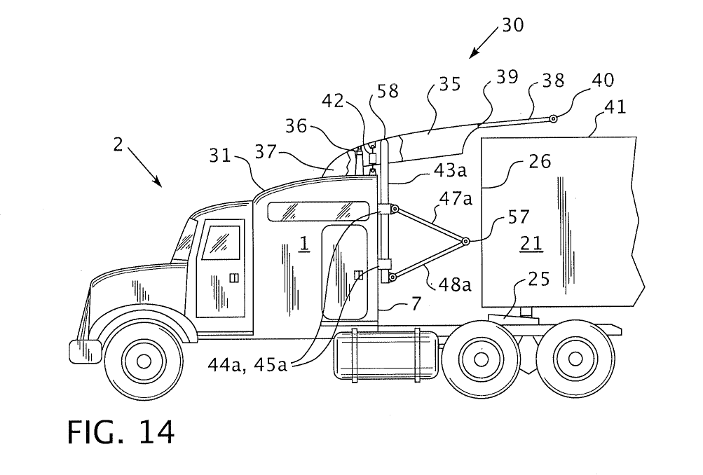

Referring to FIG. 14, in the process of trailer 21 coupling to the fifth wheel 25, as the trailer approaches the rear face 7 of the cabin 1 the front face 26 of the trailer 21 meets the intersect point between the second ends of each of the upper beams and the lower beams 47a, 47b, 48a, 48b, which in one embodiment further includes a common roller 57. As the front face 26 moves forward in engaging to the fifth wheel 25 the force imputed to intersect point of the upper and lower beams 47a, 47b, 48a, 48b is increased, wherein the force is communicated to the hinged engagement 49a, 49b of the lower beams to the vertical rods 43a, 43b in a downward direction, wherein the application of this force lowers the vertical rods 43a, 43b from contact to the fairing panel 35. Since the upper ends 58 of the vertical rods 43a, 43b are retracted downwards, the fairing panel 35 also begins to lower rotate at the hinged correction 36 to the roof surface 31 of the tractor 2. The fairing panel 35 lowers due to the downward force produced by the panel spring 42 until the roll 40 on the free end of the longitudinal beam 38 attached to the trailing end 39 of the fairing panel 35 bears up against the roof 41 of the trailer 21. As a result, irrespective of the trailer height, the fairing panel 35 is pressed to the trailer roof 41.

While a number of embodiments of the present invention have been described, it is understood that these embodiments are illustrative only, and not restrictive, and that many modifications may become apparent to those of ordinary skill in the art.

What is claimed is:

1. An air shield comprising:
side panel assemblies in hinged connection to a rear edge of each sidewall of a tractor, each of the side panel assemblies including a first panel in hinged engagement to a second panel, wherein the first panel is the hinged connection portion of the side panel assembly to the tractor, and the second panel is orientated to contact a trailer; and
an actuation assembly including a boss in rotational engagement to the frame of the tractor and positioned between a cab and a fifth wheel of the tractor, a lever having an adjustable length engaged to the boss at a first end and engaged to second panel at a second end, and a spring including a first end connected to the second panel and a second end connected to the frame of the tractor between the boss and the rear of the trailer frame.

2. The air shield of claim 1, wherein the second panel further comprises at least one roller for contacting the trailer.

3. The air shield of claim 1, wherein the adjustable length of the lever is provided by a lever slideably engaged to an eyelet formed in the boss, wherein the lever further comprises retainers on opposing sides of the boss.

4. The air shield of claim 1, wherein the adjustable length of the lever is provided by an eye formed in the lever, wherein the boss is slideably positioned within the eye of the lever.

5. The air shield of claim 1, wherein the second end of the spring is connected to a portion of the frame corresponding to the fifth wheel.

6. The air shield of claim 1, wherein the second end of the lever is connected to the lower edge of the second panel at a trailing edge of the second panel.

7. The air shield of claim 1, wherein at least one of the first and the second panel is comprised of an aluminum alloy.

8. An air shield comprising:
a panel in hinged engagement to a roof of a tractor, the panel having a length at least greater than a dimension separating a rear face of the tractor from a front face of a trailer;
a panel spring having a first end connected to the panel and a second end connected to the roof of the tractor; and
an actuating system including at first and at least a second vertical rod, wherein each of the first and the at least the second vertical rod is in sliding engagement to the rear face of the tractor by at least an upper and lower guide, and is connected to the rear face of the tractor by at least one rod spring; an upper beam connected at a first end to the upper guide for each of the first and the at least second vertical rod; and a lower beam connected to a portion of each of the first and the at least second vertical rod, wherein each of the upper beam and the lower beam intersect at a second end.

9. The air shield of claim 8, wherein the lower beam is connected to each of the vertical rods by a hinged engagement.

10. The air shield of claim 8, wherein the upper beam is connected to each of the upper guides by a hinged engagement.

11. The air shield of claim 8, further comprising a roller at the intersection of the second end of the upper and lower beam.

12. The air shield of claim 8, wherein the panel comprises a convex upper surface.

13. The air shield of claim 8 further comprising a fixed fairing positioned in front of the panel.

14. The air shield of claim 8, further comprising a longitudinal beam extending from the rear edge of the panel.

15. The air shield of claim 14, further comprising a roller positioned at the end of the longitudinal beam opposition the end in closest proximity to the rear edge of the panel.
